(19) United States
(12) Patent Application Publication
(10) Pub. No.: US 2025/0020780 A1
(43) Pub. Date: Jan. 16, 2025

(54) DRIVE CIRCUIT FOR LIGHT-EMITTING ELEMENT, ACTIVE SENSOR, AND OBJECT IDENTIFICATION SYSTEM

(71) Applicant: KOITO MANUFACTURING CO., LTD, Tokyo (JP)

(72) Inventors: Masatoshi SUZUKI, Shizuoka-shi, Shizuoka (JP); Kojl ITABA, Shizuoka-shi, Shizuoka (JP); Keita KONDO, Shizuoka-shi, Shizuoka (JP)

(73) Assignee: KOITO MANUFACTURING CO., LTD, Tokyo (JP)

(21) Appl. No.: 18/687,535

(22) PCT Filed: Aug. 29, 2022
(86) PCT No.: PCT/JP2022/032433

§ 371 Date: Oct. 2, 2024

(30) Foreign Application Priority Data
Aug. 30, 2021 (JP) 2021-139663

(51) Int. Cl. G01S 7/481; G01S 17/89

(52) U.S. Cl. CPC G01S 7/4814; G01S 17/89

(57) ABSTRACT

An input voltage V_{H} of direct current is supplied to an input terminal IN, and an output terminal OUT is connected to a semiconductor light-emitting element 402. A half-bridge circuit 510 includes a high-side transistor MH provided between the input terminal IN and a switching node SW and a low-side transistor ML provided between the switching node SW and a ground terminal GND. A control circuit 530 controls both the high-side transistor MH and the low-side transistor LH to be in an on state during a first period T1 and only the high-side transistor MH to be in the on state during a second period T2 which follows the first period T1, in response to a light emission command S1 of the semiconductor light-emitting element 402.

### TECHNICAL FIELD

The present disclosure relates to a drive circuit for a light-emitting element.

### BACKGROUND ART

An object identification system that senses a location and a type of an object around a vehicle is used for automatic driving or automatic control of a light distribution of a headlamp. The object identification system includes a sensor and an arithmetic processing device that analyzes an output of the sensor. The sensor is selected from a camera, a light detection and ranging or laser imaging detection and ranging (LiDAR), a millimeter-wave radar, an ultrasonic sonar, and the like, considering use, required precision, and cost.

The sensor includes a passive sensor and an active sensor. The passive sensor detects light emitted by an object or light reflected by an object from environmental light, and the sensor itself does not emit light. On the other hand, the active sensor irradiates an object with illumination light and detects reflected light thereof. The active sensor mainly includes a light projector (illuminator) that irradiates an object with illumination light and a light sensor that detects reflected light from the object. The active sensor has an advantage of being able to increase resistance to disturbances over the passive sensor by matching a wavelength of the illumination light and a sensitivity wavelength range of the sensor.

### CITATION LIST

### Patent Literature

Patent Literature 1: JP2019-257983A
Patent Literature 2: WO2017/110413A1
Patent Literature 3: JP2019-68528A

### SUMMARY OF INVENTION

### Technical Problem

A LiDAR, a ToF camera, and a gating camera, which are active sensors, irradiate a field of view with pulse-shaped illumination light (pulse illumination light). In order to increase a distance resolution, it is necessary to narrow a pulse width of the pulse illumination light. With a circuit described in Patent Literature 3, it is difficult to generate a narrow pulse current with a pulse width of several nanoseconds (ns) (for example, 2 nanoseconds).

Furthermore, if the pulse width is narrowed to a certain extent, the influence of parasitic inductance in a drive circuit cannot be ignored, a slew rate of a drive current decreases, and waveform rounding becomes noticeable.

One aspect of the present disclosure has been made in view of the above situations, and one of exemplary objects thereof is to provide a drive circuit capable of generating a pulse current of several nanoseconds. Another exemplary object is to provide a drive circuit with improved slew rate of a drive current.

### Solution to Problem

One aspect of the present disclosure relates to a drive circuit for a semiconductor light-emitting element. The drive circuit includes an input terminal configured to receive an input voltage of direct current, an output terminal connected to the semiconductor light-emitting element, a half-bridge circuit including a high-side transistor provided between a switching node connected to the output terminal and the input terminal and a low-side transistor provided between the switching node and a ground terminal, and a control circuit configured to control both the high-side transistor and the low-side transistor to be in an on state during a first period and the high-side transistor to be in the on state and the low-side transistor to be in an off state during a second period which follows the first period, in response to a light emission command of the semiconductor light-emitting element.

Note that optional combinations of the constituent elements described above and mutual substitutions of constituent elements or expressions among methods, apparatuses, systems or the like are also valid as aspects of the present invention or present disclosure. Furthermore, the description of this item (SUMMARY OF INVENTION) does not describe all the indispensable features of the present invention, and therefore, the sub-combinations of these features described can also be the present invention.

### Advantageous Effects of Invention

According to the present disclosure, it is possible to generate a pulse current with several nanoseconds. Furthermore, it is possible to improve a slew rate of a drive current.

### BRIEF DESCRIPTION OF DRAWINGS

FIG. 1 is a circuit diagram of a light-emitting device 400 according to an embodiment.

FIGS. 2A and 2B are equivalent circuit diagrams showing current paths of a drive circuit 500 during a first period T1 and during a second period T2 of the drive circuit of FIG. 1.

FIG. 3 is an operation waveform diagram of the drive circuit 500 of FIG. 1.

FIG. 4 is a circuit diagram of a calculation circuit model of a drive circuit used in a simulation.

FIG. 5A is a waveform diagram of a control signal of the drive circuit according to the embodiment, and FIG. 5B is a waveform diagram of a control signal of a drive circuit according to Comparative Technology 1.

FIGS. 6A and 6B are waveform diagrams showing voltages and currents generated at a plurality of nodes in the drive circuit according to the embodiment.

FIG. 7 is a waveform diagram showing a drive current I_{DRV} in the embodiment and a drive current I_{DRV} in Comparative Technology 1.

FIG. 8 is a waveform diagram showing a drive current I_{DRV1} (solid line) in the embodiment, a drive current I_{DRV2} (broken line) in Comparative Technology 1, and a drive current I_{DRV3} (dash-dotted line) in Comparative Technology 2.

FIG. 9A is a diagram showing dependency of coil currents I_{L1} to I_{L3} and drive current I_{DRV} on a length of a short time T2, and FIG. 9B is a diagram showing dependency of a drive voltage V_{DRV} on the length of the short time T2.

FIG. 10 is a circuit diagram of a part of a drive circuit according to Variation 1.

FIG. 11 is a block diagram of an active sensor according to an embodiment.

FIG. 12 is a block diagram of a gating camera according to an embodiment.

FIG. 13 is a diagram illustrating an operation of the gating camera of FIG. 12.

FIGS. 14A and 14B are diagrams illustrating images obtained by the gating camera.

FIG. 15 is a diagram showing a vehicle lamp with a built-in active sensor.

FIG. 16 is a block diagram showing a vehicle lamp including an object identification system.

### DESCRIPTION OF EMBODIMENTS

### Outline of Embodiments

An outline of several exemplary embodiments of the present disclosure will be described. The outline is a simplified explanation regarding several concepts of one or multiple embodiments as an introduction to the detailed description described below in order to provide a basic understanding of the embodiments, and is by no means intended to limit the scope of the present invention or disclosure. The outline is by no means a comprehensive outline of all contemplated embodiments, and is by no means intended to specify essential elements of all embodiments or to delimit the scope of any or all aspects. For convenience, in some cases, “one embodiment” as used herein refers to a single embodiment (embodiment or variation) or a plurality of embodiments (embodiments or variations) disclosed in the present specification.

A drive circuit for a semiconductor light-emitting element according to one embodiment includes an input terminal configured to receive an input voltage of direct current, an output terminal connected to the semiconductor light-emitting element, a half-bridge circuit including a high-side transistor provided between a switching node connected to the output terminal and the input terminal and a low-side transistor provided between the switching node and a ground terminal, and a control circuit configured to control both the high-side transistor and the low-side transistor to be in an on state during a first period and the high-side transistor to be in the on state and the low-side transistor to be in an off state during a second period which follows the first period, in response to a light emission command for the semiconductor light-emitting element.

During the first period for which both the high-side transistor and the low-side transistor are in an on state, energy can be accumulated in a minute inductor component included in the bridge circuit. Subsequently, by turning off the low-side transistor and shifting to the second period, a drive voltage that is applied to the semiconductor light-emitting element increases steeply. Thereby, a drive current with a steep slope can be supplied to the semiconductor light-emitting element.

According to this configuration, a narrow pulse current with a pulse width of several nanoseconds (for example, 2 nanoseconds) can be generated. Furthermore, a voltage of input voltage required to generate a certain peak current can be significantly reduced compared to other methods.

In one embodiment, breakdown voltages of the high-side transistor and the low-side transistor may be 2.5 times or higher than the input voltage.

In one embodiment, the high-side transistor and the low-side transistor may be GaN-FETs (Field-Effect Transistors).

In one embodiment, a length of a wiring pattern from the input terminal to the switching node via the high-side transistor may be longer than 100 μm. Furthermore, in one embodiment, a length of a wiring pattern from the ground terminal to the switching node via the low-side transistor may be longer than 100 μm. This allows optimal parasitic inductance to be introduced by the wiring pattern.

In one embodiment, the drive circuit may further include a ferrite bead provided between an output node of a power supply circuit configured to generate the input voltage and the high-side transistor. In one embodiment, the drive circuit may further include a feedthrough capacitor connected to the input terminal. This allows noise leaking from the bridge circuit to the power supply circuit to be reduced.

In one embodiment, the control circuit may turn off the high-side transistor and the low-side transistor during a third period which follows the second period.

An active sensor according to one embodiment includes a light-emitting device configured to irradiate a field of view with pulse illumination light and a light sensor configured to receive reflected light of the pulse illumination light from the field of view. The light-emitting device may include a semiconductor light-emitting element and any of the aforementioned drive circuits configured to drive the semiconductor light-emitting element.

### Embodiments

Hereinafter, favorable embodiments will be described with reference to the drawings. The same or equivalent components, members and processing shown in each drawing are denoted with the same reference numerals, and repeated descriptions will be omitted appropriately. Furthermore, the embodiments are illustrative, not limiting the present disclosure and invention, and all features described in the embodiments and combinations thereof are not necessarily essential features of the present disclosure and invention.

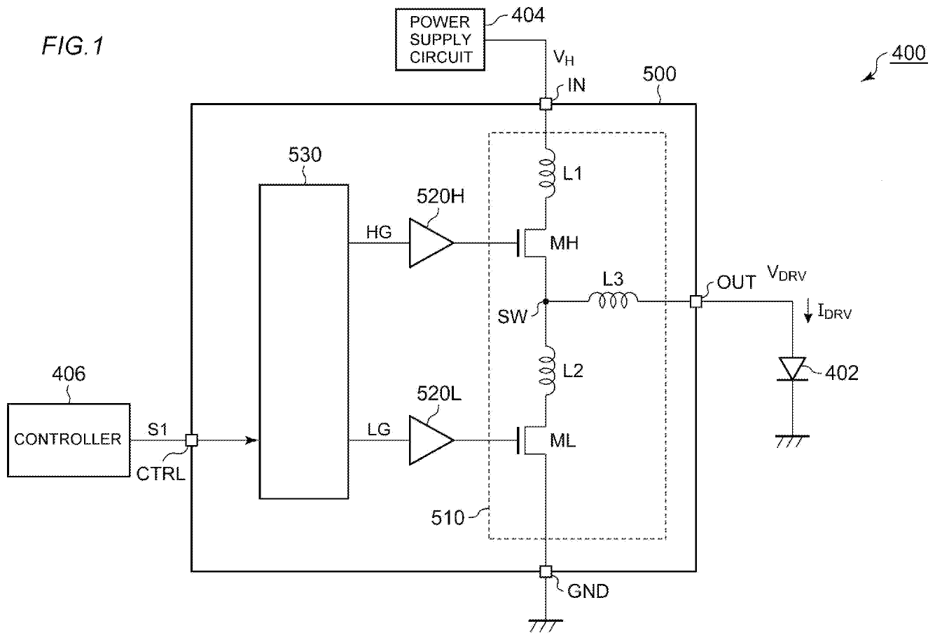

FIG. 1 is a circuit diagram of a light-emitting device 400 according to an embodiment. The light-emitting device 400 generates narrow pulse illumination light with a pulse width on the order of nanoseconds. The light-emitting device 400 includes a semiconductor light-emitting element (hereinafter simply referred to as a light-emitting element) 402, a power supply circuit 404, a controller 406, and a drive circuit 500.

The light-emitting element 402 is a laser diode (LD), a light-emitting diode (LED), an organic electro luminescence (EL) element, or the like.

The power supply circuit 404 generates an input voltage V_{H} of direct current. The input voltage V_{H} is supplied to an input terminal IN of the drive circuit 500. For example, the power supply circuit 404 may be a switching power supply such as a step-up converter, a step-up/step-down converter, a step-down converter, or a charge pump circuit.

The controller 406 generates a light emission command S1, which is a timing signal indicating a light emission timing, and supplies the light emission command to a control terminal CTRL of the drive circuit 500.

An anode of the light-emitting element 402 is connected to an output terminal OUT of the drive circuit 500. In response to assertion of the light emission command S1, the drive circuit 500 supplies the light-emitting element 402 with a drive current I_{DRV} with a pulse width on the order of nanoseconds.

The drive circuit 500 includes a half-bridge circuit 510, pre-drivers 520H and 520L, and a control circuit 530. The half-bridge circuit 510 includes a high-side transistor MH and a low-side transistor ML. The high-side transistor MH is provided between the input terminal IN and a switching node SW connected to the output terminal OUT. The low-side transistor ML is provided between the switching node SW and a ground terminal GND. The switching node SW is connected to the output terminal OUT.

In order to realize a pulse width of several nanoseconds, it is necessary to switch the high-side transistor MH and the low-side transistor ML at high speed. Therefore, as the high-side transistor MH and the low-side transistor ML, it is preferable to use a transistor with excellent high-frequency characteristics, for example, GaN-FET (Field-Effect Transistor).

The half-bridge circuit 510 includes inductors L1 to L3. The inductor L1 indicates an inductance component in series with the high-side transistor MH between the input terminal IN and the switching node SW. The inductor L2 indicates an inductance component in series with the low-side transistor ML between the switching node SW and the ground terminal GND. The inductor L3 indicates an inductance component between the switching node SW and a cathode of the light-emitting element 402.

The inductors L1 to L3 are parasitic inductances of a patterned wiring, a via hole, a wire and the like on a printed circuit board. As described below, the parasitic inductance is a critical parameter that defines short-circuit current I_{SHORT} or magnetic energy accumulated in the inductors L1 and L2, and for example, is preferably within a range of 0.1 nH to 0.5 nH.

The parasitic inductance is preferably designable and adjustable, and from this point of view, it is preferable to use a patterned wiring on a printed circuit board. That is, the inductor L1 is formed using a wiring pattern on the printed circuit board on which the high-side transistor MH is mounted, and a parasitic inductance of the wiring pattern may be greater than 0.1 nH. A wiring length of the wiring pattern may be longer than 100 μm, for example. The wiring length of the wiring pattern is a length of a portion excluding a land where a terminal portion of the high-side transistor MH is soldered.

Similarly, the inductor L2 is formed using a wiring pattern on the printed circuit board on which the low-side transistor ML is mounted, and a parasitic inductance of the wiring pattern may be greater than 0.1 nH. A wiring length of the wiring pattern may be longer than 100 μm, for example. The wiring length of the wiring pattern is a length of a portion excluding a land where a terminal portion of the low-side transistor ML is soldered.

The control circuit 530 generates, in response to the light emission command S1, signals HG and LG so that both the high-side transistor MH and the low-side transistor ML become on during a first period T1 and only the high-side transistor MH becomes on during a second period T2 which follows the first period T1. The first period T1 is also called a short time, and the second period T2 is also called a light emission period.

The pre-drivers 520H and 520L are gate drivers. The pre-driver 520H drives the high-side transistor MH, in response to the control signal HG, and the pre-driver 520L drives the low-side transistor ML, in response to the control signal LG.

The above is the configuration of the drive circuit 500. Subsequently, operations thereof will be described.

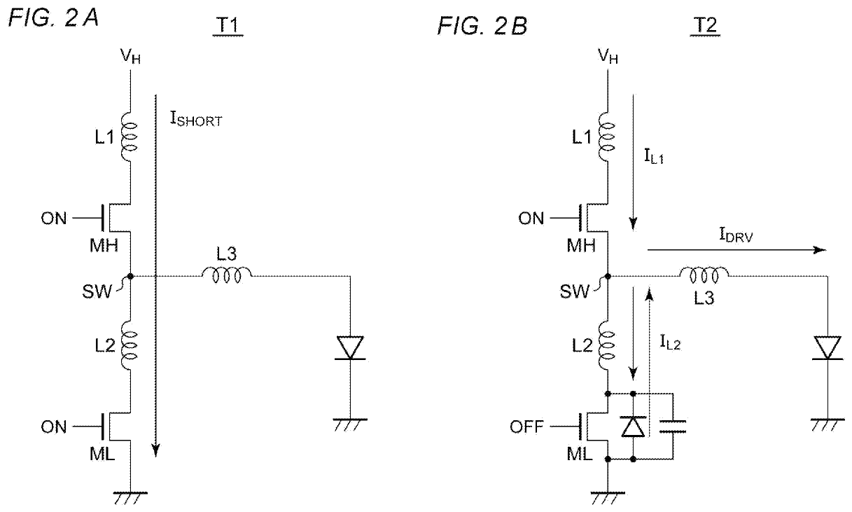

FIGS. 2A and B are equivalent circuit diagrams showing current paths of the drive circuit 500 during the first period T1 and during the second period T2 of the drive circuit 500 of FIG. 1. As shown in FIG. 2A, during the short time T1, the high-side transistor MH and the low-side transistor ML are simultaneously on, so the input voltage V_{H} is applied between both ends of a series connection circuit of the inductors L1 and L2. For ease of understanding, assuming that on-resistances of the high-side transistor MH and low-side transistor ML are zero, a current I_{SHORT} flows from the input terminal IN toward the ground terminal GND via the inductors L1 and L2. The current I_{SHORT} is represented by Equation (1) and increases at a constant slope with time.

$${I}_{SHORT} = 1 / ( L 1 + L 2 ) \times \int {V}_{H} dt = {V}_{H} / ( L 1 + L 2 ) \times t \qquad ( 1 )$$

Magnetic energies E1 and E2 are accumulated in the inductors L1 and L2, respectively.

E1=½·L1×I_{SHORT}²

E2=½·L2×I_{SHORT}²

As shown in FIG. 2B, during the light emission period T2, since the low-side transistor ML is off, a high-side current I_{L1} flowing through the inductor L1 and the high-side transistor MH is supplied to the light-emitting element 402 via the inductor L3. Note that during the light emission period T2, a current I_{L2} flowing through the inductor L2 does not become zero, and becomes

I_{DRV}=I_{L3}=I_{L1}−I_{L2}

A positive coil current I_{L2} flows into a drain capacitance of the low-side transistor ML, and a negative coil current I_{L2} flows from the ground terminal toward the switching node SW via a body diode of the low-side transistor ML.

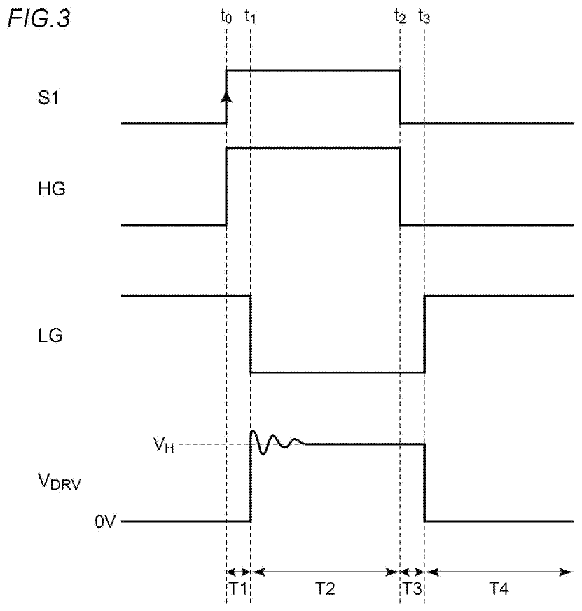

FIG. 3 is an operation waveform diagram of the drive circuit 500 of FIG. 1. For the control signals HG and LG, high (H) corresponds to on and low (L) corresponds to off.

Before time t0, the control signal HG is L, the control signal LG is H, the high-side transistor MH is off, and the low-side transistor ML is on. The drive voltage V_{DRV} of 0V is supplied to the cathode of the light-emitting element 402.

At time t0, the light emission command S1 becomes high (H). The control circuit 530 changes the control signal HG to H in response to assertion of the light emission command S1. This causes a transition to the short time T1 and both the high-side transistor MH and low-side transistor ML to be on.

At time t₁ after the first period T1 has elapsed, the control circuit 530 changes the control signal LG to L. This causes a transition to the light emission period T2 for which the low-side transistor ML is turned off and only the high-side transistor MH is on.

At time t₁, when the low-side transistor ML is turned off, the drive voltage V_{DRV} is increased steeply by the magnetic energy accumulated in the inductors L1 and L2. This also causes the drive current I_{DRV} flowing through the light-emitting element 402 to rise sharply.

At time t2, when the light emission command S1 becomes low (L), the control signal HG becomes low, the high-side transistor MH is turned off, and the transition to a third period (dead time) T3 is made. At subsequent time t3, the control signal LG becomes high, and the transition to a fourth period (standby period) T4 is made.

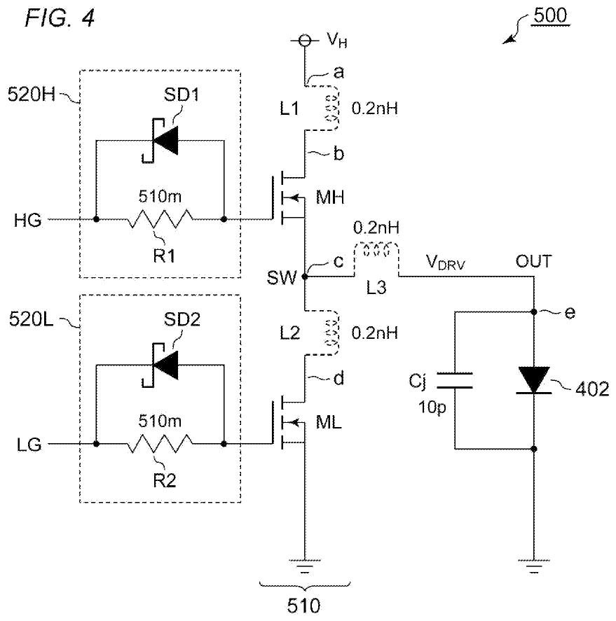

Next, a simulation result of the drive circuit 500 according to the embodiment will be described. FIG. 4 is a circuit diagram of a calculation circuit model of the drive circuit 500 used in a simulation. The inductors L1 to L3 are set to 0.2 nH. Cj is a junction capacitance of the light-emitting element 402, and its capacitance value is set to 10 pF. The pre-driver 520H includes a gate resistor (charge resistor) R1 for turn-on and a Schottky diode SD1 for turn-off. Similarly, the pre-driver 520L includes a gate resistor R2 for turn-on and a Schottky diode SD2 for turn-off. Resistance values of the gate resistors R1 and R2 were set to 510 mΩ.

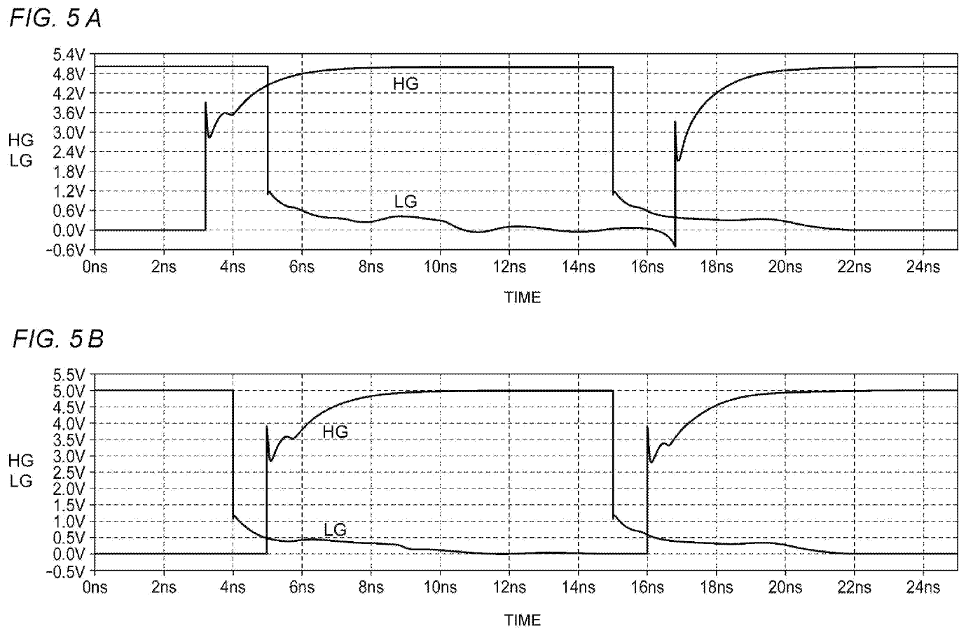

FIG. 5A is a waveform diagram of a control signal of the drive circuit 500 according to the embodiment. The control signals HG and LG are indicated based on source voltages of the high-side transistor MH and low-side transistor ML, respectively. A length of the light emission period T2 is 10 nanoseconds, and a length of the short time T1 is 2 nanoseconds.

FIG. 5B is a waveform diagram of a control signal of a drive circuit according to Comparative Technology 1. In Comparative Technology 1, a dead time T3 is inserted as in an inverter control of the related art. Here, a length of the dead time is set to 1 nanosecond. A length of the emission period T2 is 10 nanoseconds.

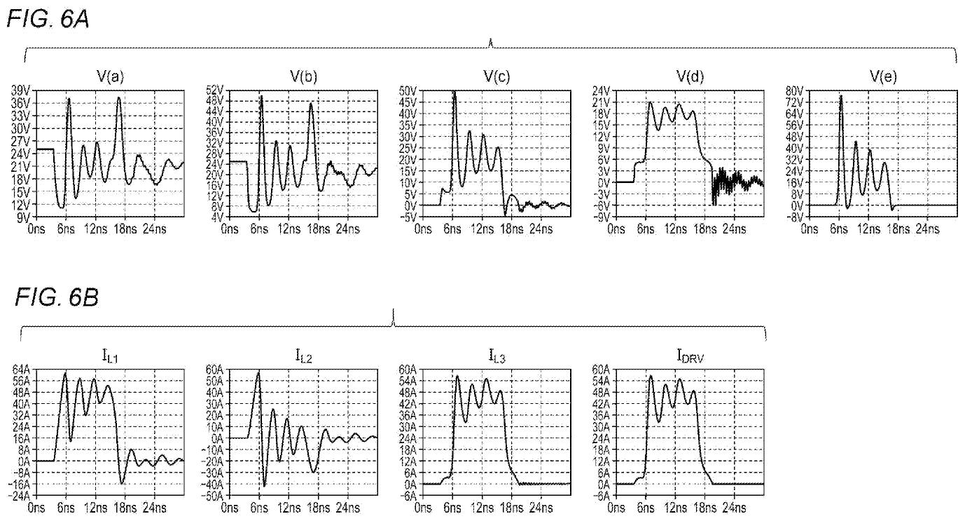

FIGS. 6A and 6B are waveform diagrams showing voltages and currents generated at a plurality of nodes in the drive circuit 500 according to the embodiment. In FIG. 6A, waveforms of voltages V(a) to V(e) at the nodes a to e of FIG. 4 are shown, and in FIG. 6B, the currents I_{L1}, I_{L2}, I_{L3} of the inductors L1 to L3 and the drive current I_{DRV} are shown.

Referring to the voltage V(a) at the node a shown in FIG. 6A, the voltage rises up to around 37V beyond the input voltage V_{H}=25V generated by the power supply circuit 404. Furthermore, the voltages V(b) and V(c) at the node b and the node c also rise up to around 50V. Therefore, the breakdown voltage of the high-side transistor MH or low-side transistor ML is not sufficient to be on the same level as the input voltage V_{H} and is 2 times or higher, preferably 2.5 times or higher, and more preferably 3 times or higher than the input voltage V_{H}.

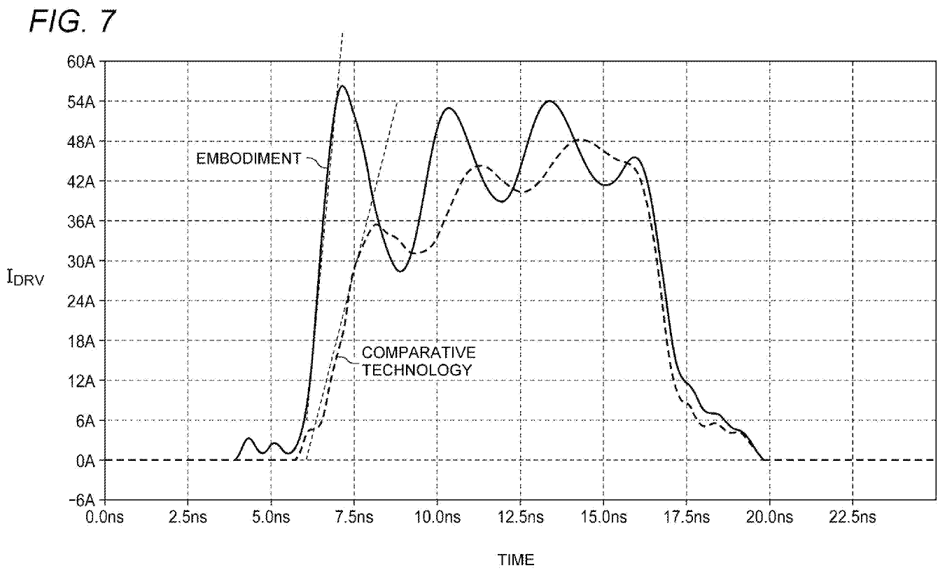

FIG. 7 is a waveform diagram showing the drive current I_{DRV} in the embodiment and the drive current I_{DRV} in Comparative Technology 1. The solid line indicates the embodiment, i.e., the drive current I_{DRV} based on the control signal shown in FIG. 5A, and the broken line indicates Comparative Technology 1, i.e., the drive current I_{DRV} based on the control signal shown in FIG. 5B.

It can be seen that in Comparative Technology 1, the rising speed (slew rate) of the drive current I_{DRV} is 19.1 kA/μs, whereas in the present embodiment, the rising speed (slew rate) of the drive current I_{DRV} is 62.3 kA/μs, which is approximately 3 times. That is, according to the present embodiment, when the pulse width is long to a certain extent (for example, 10 nanoseconds or longer), it is possible to make the current waveform closer to a rectangular waveform shape.

Next, other advantages of the drive circuit 500 according to the embodiment will be described by comparison with Comparative Technology 1 and the related art disclosed in Patent Literature 3 (hereinafter, referred to as Comparative Technology 2). In Comparative Technology 2, a capacitor that is charged prior to light emission is provided. The light-emitting element and the switch are connected between both ends of the capacitor, and when the switch turns on, the charges charged in the capacitor flow through the light-emitting element as a drive current. The method of Comparative Technology 2 is called a capacitor discharge method.

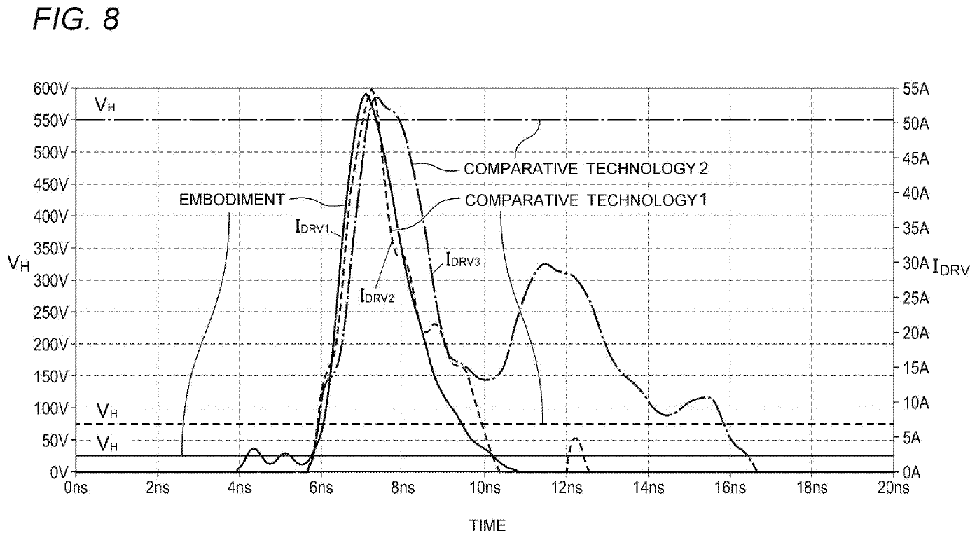

FIG. 8 is a waveform diagram showing a drive current I_{DRV1} (solid line) in the embodiment, a drive current I_{DRV2} (broken line) in Comparative Technology 1, and a drive current I_{DRV3} (dash-dotted line) in Comparative Technology 2. Here, it is targeted to generate the drive current I_{DRV} having a Gaussian waveform with a pulse width of 2 nanoseconds. The input voltage V_{H} in the embodiment is 25V, a peak of the drive current I_{DRV1} is 54 A, and the pulse width is 2 ns.

In Comparative Technology 2 (capacitor discharge type), it is difficult to generate a Gaussian waveform with a pulse width of 2 nanoseconds due to the effect of the parasitic inductance of each component.

In order to obtain a peak (55A) of the drive current I_{DRV} that is the same level as the embodiment, the input voltage V_{H} of 75V is required in Comparative Technology 1. In Comparative Technology 2, an input voltage (capacitor voltage) of 550V is required. That is, according to the present embodiment, the required voltage of the input voltage V_{H} can be reduced to about ⅓ times compared to Comparative Technology 1 and to about 1/22 times compared to Comparative Technology 2.

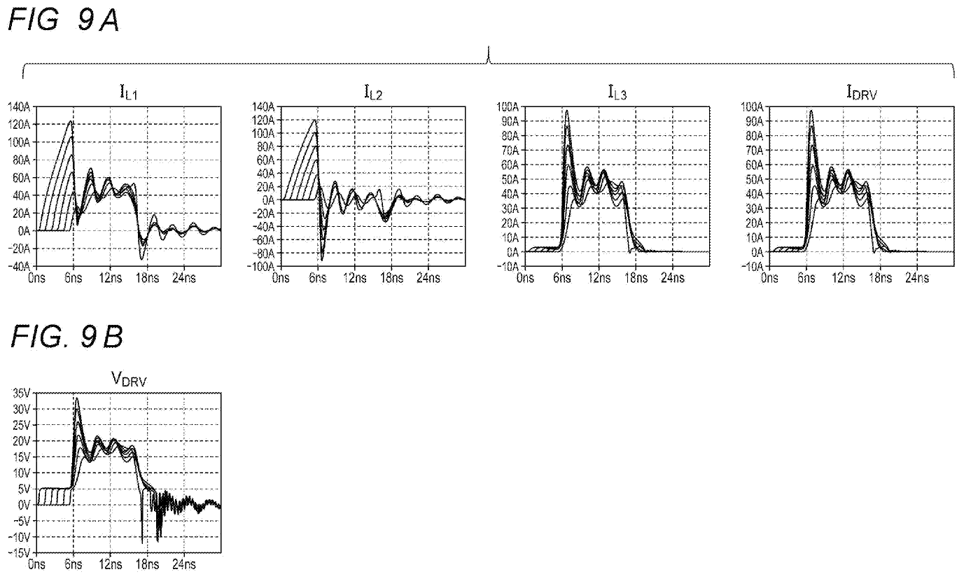

FIG. 9A is a diagram showing dependency of the coil currents I_{L1} to I_{L3} and drive current I_{DRV} on the length of the short time T2, and FIG. 9B is a diagram showing dependency of the drive voltage V_{DRV} on the length of the short time T2. The short time T2 is changed in a 1 nanosecond step between 0 and 5 nanoseconds. As the short time T2 is lengthened, the magnetic energy accumulated in the coils L1 and L2 during the short time increases, so the slew rates of the rise in the drive voltage V_{DRV} and the drive current I_{DRV} can be increased.

Next, countermeasures against the noise will be described. As shown in FIG. 6A, the voltage V(a) at the node a in FIG. 4 largely vibrates while exceeding the direct current voltage V_{H} generated by the power supply circuit 404. If this vibration is input to the power supply circuit 404, there is a concern about an adverse effect on other circuits, such as exceeding the breakdown voltage of an output smoothing capacitor in the power supply circuit 404.

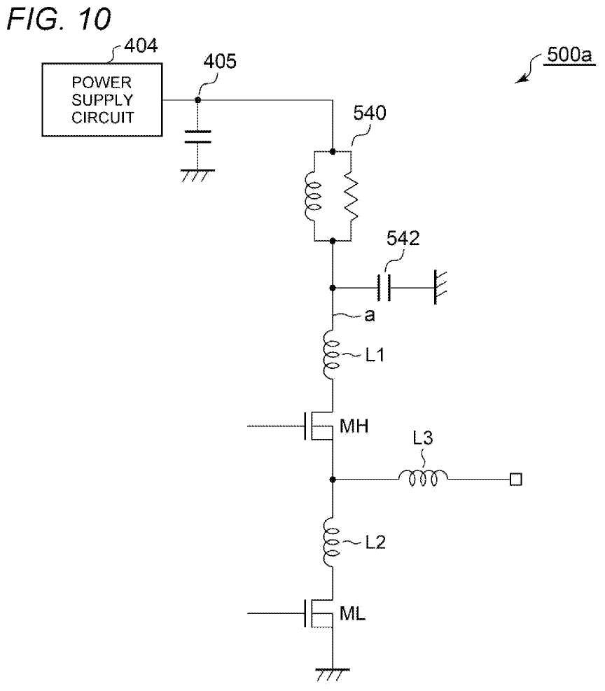

FIG. 10 is a circuit diagram of a part of a drive circuit 500a according to Variation 1. The drive circuit 500a includes a ferrite bead 540 and a feedthrough capacitor 542. The ferrite bead 540 is provided between the output node 405 of the power supply circuit 404 and the high-side transistor MH. Furthermore, the feedthrough capacitor 542 is connected between the input terminal IN and the ground terminal of the drive circuit 500a.

According to this configuration, noise resulting from a voltage oscillation occurring at the node a can be blocked, making it possible to prevent an adverse effect on the power supply circuit 404.

The feedthrough capacitor 542 may be omitted and only the ferrite bead 540 may be provided, or the ferrite bead 540 may be omitted and only the feedthrough capacitor 542 may be provided.

### (Use)

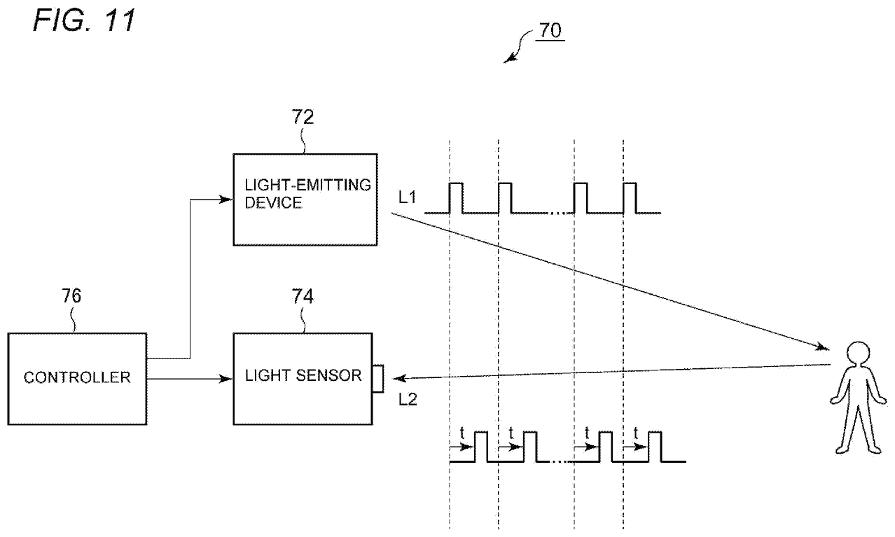

FIG. 11 is a circuit block diagram of an active sensor 70 according to an embodiment. The active sensor 70 is a gating camera, a ToF camera, a LIDAR, or the like, and includes a light-emitting device 72, a light sensor 74, and a controller 76.

The light-emitting device 72 emits pulse light multiple times during one sensing and irradiates a field of view with pulse illumination light. The light-emitting device 72 includes the light-emitting device 400 of FIG. 1.

Light L1 emitted from the light-emitting device 72 is reflected by an object OBJ and is incident on the light sensor 74. The reflected light L2 is delayed by τ with respect to the emitted light L1. τ corresponds to a distance z to the object OBJ and is represented by Equation (2). τ is called a round trip time of light.

$$τ = 2 \times z / c \qquad ( 2 )$$

in which c represents the speed of light.

An exposure timing and an exposure time of the light sensor 74 are controlled so that each pulse included in the reflected light L1 can be detected in synchronization with each light emission of the light-emitting device 72. A light emission timing of the light-emitting device 72 and the exposure timing of the light sensor 74 are controlled by the controller 76. The light sensor 74 may be a single-pixel detector or an image sensor.

The reflected light L2 from the object is incident on the light sensor 74 multiple times, in response to the plurality of times of light emissions of the light-emitting device 72. The light sensor 74 integrates the reflected light received multiple times and outputs a signal corresponding to an integrated value.

Next, the use of the active sensor 70 will be described. One embodiment of the active sensor 70 is a gating camera.

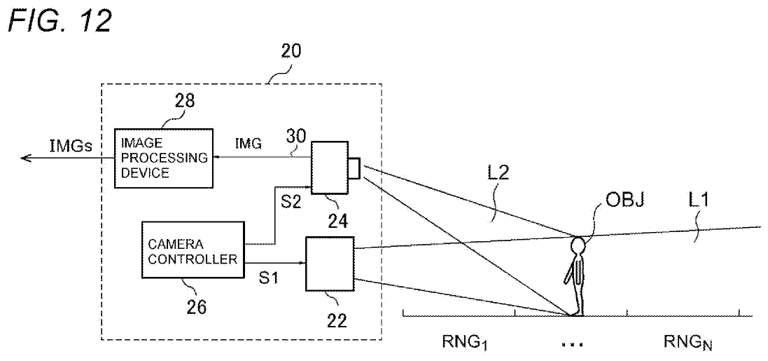

FIG. 12 is a block diagram of a gating camera 20. The gating camera 20 divides an area into N ranges RNG₁ to RNG_{N} (N≥2) in a depth direction, and performs imaging.

The gating camera 20 includes an illumination device 22, an image sensor 24, a controller 26, and an image processing unit 28. The illumination device 22 corresponds to the light-emitting device 72 in FIG. 11, the image sensor 24 corresponds to the light sensor 74 in FIG. 11, and the controller 26 corresponds to the controller 76 in FIG. 11.

The illumination device 22 irradiates a field of view with illumination light L1 having a plurality of pulses in synchronization with a light emission timing signal S1 provided from the controller 26. The illumination light L1 is preferably infrared light, but is not limited thereto, and may be visible light having a predetermined wavelength.

The image sensor 24 is configured to be capable of performing exposure control in synchronization with an imaging timing signal S2 provided from the controller 26 and to be capable of generating a slice image IMG. The image sensor 24 has sensitivity to the same wavelength as the illumination light L1 and captures the reflected light (return light) L2 reflected by the object OBJ.

The controller 26 maintains predetermined light projection timing and exposure timing for each range RNG. When imaging any range RNGᵢ, the controller 26 generates an emission timing signal S1 and an imaging timing signal S2 on the basis of the light projection timing and exposure timing corresponding to the range and performs the imaging. The gating camera 20 can generate a plurality of slice images IMG₁ to IMG_{N} corresponding to the plurality of ranges RNG₁ to RNG_{N}. In an i-th slice image IMGᵢ, an object included in the corresponding range RNGᵢ appears.

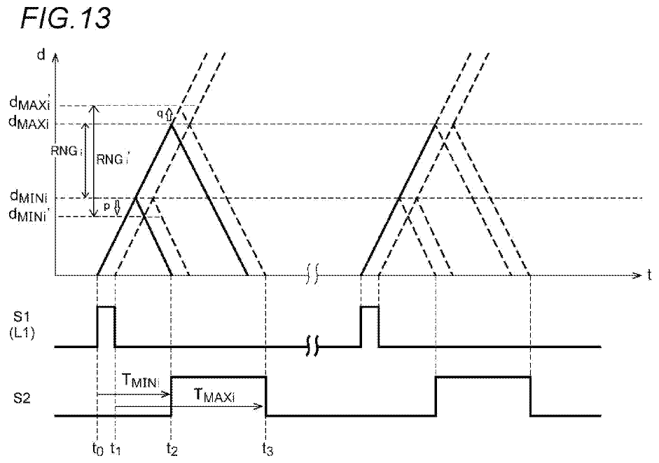

FIG. 13 is a diagram illustrating an operation of the gating cameras 20 of FIG. 12. FIG. 13 shows an aspect when measuring the i-th range RNGᵢ. The illumination device 22 emits light during a light emission period τ₁ between time t₀ and time t₁ in synchronization with the light emission timing signal S1. At the top, a diagram of a light beam where a time is indicated on the horizontal axis and a distance is indicated on the vertical axis is shown. A distance from the gating camera 20 to a front side boundary of the range RNGi is set to d_{MINi} and a distance from the gating camera 20 to a deep side boundary of the range RNGi is set to d_{MAXi}.

Round-trip time T_{MINi} from when light emitted from the illumination device 22 at a certain time point reaches the distance d_{MINi} to when reflected light returns to the image sensor 24 is expressed as

T_{MINi}=2×d_{MINi}/c, in which c is the speed of light.

Similarly, round-trip time T_{MAXi} from when light emitted from the illumination device 22 at a certain time point reaches the distance d_{MAXi} to when reflected light returns to the image sensor 24 is expressed as

T_{MAXi}=²×d_{MAXi}/c.

When it is desired to image the object OBJ included in the range RNGᵢ, the controller 26 generates the imaging timing signal S2 so that the exposure starts at a time point t₂=t₀+T_{MINi} and ends at a time point t₃=t₁+T_{MAXi}. This is one exposure operation.

When imaging the i-th range RNGᵢ, the light emission and the exposure are repeatedly performed multiple times, and measurement results are integrated by the image sensor 24.

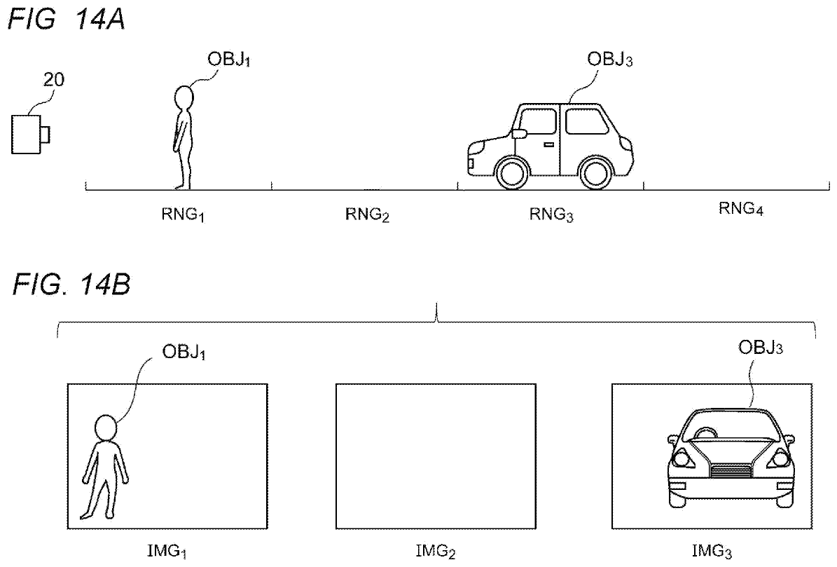

FIGS. 14A and 14B are views illustrating images obtained by the gating camera 20. In the example of FIG. 14A, an object (pedestrian) OBJ₁ is present in the range RNG₁ and an object (vehicle) OBJ₃ is present in the range RNG₃. FIG. 14B shows a plurality of slice images IMG₁ to IMG₃ obtained in a situation in FIG. 14A. When the slice image IMG₁ is captured, an object image OBJ₁ of the pedestrian OBJ₁ appears in the slice image IMG₁ since the image sensor is exposed only to reflected light from the range RNG₁.

When the slice image IMG₂ is captured, no object image appears in the slice image IMG₂ since the image sensor is exposed to reflected light from the range RNG₂.

Similarly, when the slice image IMG₃ is captured, only the object image OBJ₃ appears in the slice image IMG₃ since the image sensor is exposed only to reflected light from the range RNG₃. In this way, an object can be separately imaged on a range basis by the gating camera 20.

The above is the operation of the gating camera 20. In the gating camera, by making the time intervals of light emission of the illumination device 22 non-uniform, the effect of the surrounding pulse light source can be reduced, so a clear image with less noise components can be obtained.

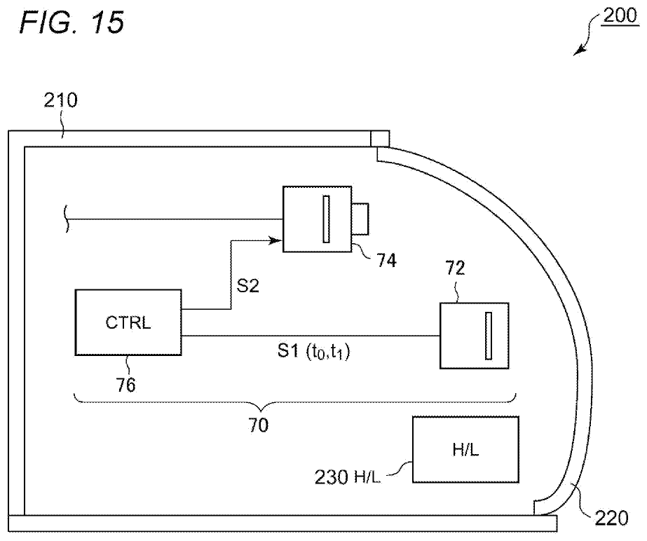

FIG. 15 is a diagram showing a vehicle lamp 200 with a built-in active sensor 70. The vehicle lamp 200 includes a housing 210, an outer lens 220, lamp units 230H/230L for high beam and low beam, and an active sensor 70. The lamp units 230H/230L and the active sensor 70 are accommodated in the housing 210.

Note that a part of the active sensor 70, for example, the light sensor 74 may be installed outside the vehicle lamp 200, for example, behind a room mirror.

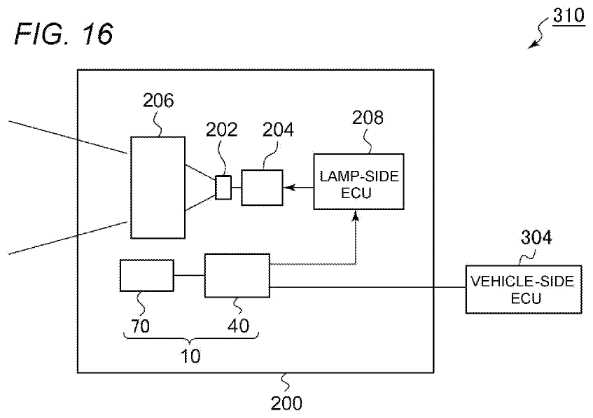

FIG. 16 is a block diagram showing a vehicle lamp 200 including an object identification system 10. The vehicle lamp 200 constitutes a lamp system 310 together with a vehicle-side ECU 304. The vehicle lamp 200 includes a light source 202, a lighting circuit 204, and an optical system 206. Further, the vehicle lamp 200 includes an object identification system 10. The object identification system 10 includes an active sensor 70 and an arithmetic processing device 40.

The arithmetic processing device 40 is configured to be capable of identifying a type of an object on the basis of an image obtained by the active sensor 70. The arithmetic processing device 40 includes a classifier installed on the basis of a prediction model generated by machine learning. An algorithm of the classifier is not particularly limited, but YOLO (You Only Look Once), SSD (Single Shot MultiBox Detector), R-CNN (Region-based Convolutional Neural Network), SPPnet (Spatial Pyramid Pooling), Faster R-CNN, DSSD (Deconvolution-SSD), Mask R-CNN and the like may be adopted, or algorithms to be developed in the future may be adopted.

The arithmetic processing device 40 may be implemented by a combination of a processor (hardware) such as a central processing unit (CPU), a microprocessing unit (MPU) and a microcomputer and a software program executed by the processor (hardware). The arithmetic processing device 40 may be a combination of a plurality of processors. Alternatively, the arithmetic processing device 40 may be configured by only hardware.

Information about the object OBJ detected by the arithmetic processing device 40 may be used for light distribution control of the vehicle lamp 200. Specifically, a lamp-side ECU 208 generates a proper light distribution pattern on the basis of information about a type and a position of the object OBJ generated by the arithmetic processing device 40. The lighting circuit 204 and the optical system 206 operate so that the light distribution pattern generated by the lamp-side ECU 208 is obtained.

Furthermore, the information about the object OBJ detected by the arithmetic processing device 40 may be transmitted to the vehicle-side ECU 304. The vehicle-side ECU may perform automatic driving on the basis of the information.

The embodiments are merely illustrative, and it should be understood by one skilled in the art that various variations can be made to combinations of components and processing processes in the embodiments and such variations also fall within the scope of the present invention.

### INDUSTRIAL APPLICABILITY

The present disclosure relates to a drive circuit for a light-emitting element.

### REFERENCE SIGNS LIST

10 . . . object identification system, OBJ . . . object, 20 . . . gating camera, 22 . . . illumination device, 24 . . . image sensor, 26 . . . controller, S1 . . . light emission timing signal, S2 . . . imaging timing signal, 40 . . . arithmetic processing device, 70 . . . active sensor, 72 . . . light-emitting device, 74 . . . light sensor, 76 . . . controller, 200 . . . vehicle lamp, 202 . . . light source, 204 . . . lighting circuit, 206 . . . optical system, 310 . . . lamp system, 304 . . . vehicle-side ECU, 400 . . . light-emitting device, 402 . . . light-emitting element, 500 . . . drive circuit, 510 . . . half-bridge circuit, MH . . . high-side transistor, ML . . . low-side transistor, 520 . . . pre-driver, 530 . . . control circuit.

1. A drive circuit for a semiconductor light-emitting element, the drive circuit comprising:
an input terminal configured to receive an input voltage of direct current;
an output terminal connected to the semiconductor light-emitting element;
a half-bridge circuit including a high-side transistor provided between a switching node connected to the output terminal and the input terminal, and a low-side transistor provided between the switching node and a ground terminal; and
a control circuit configured to control both the high-side transistor and the low-side transistor to be in an on state during a first period, and the high-side transistor to be in the on state and the low-side transistor to be in an off state during a second period which follows the first period, in response to a light emission command of the semiconductor light-emitting element.

2. The drive circuit according to claim 1, wherein breakdown voltages of the high-side transistor and the low-side transistor are 2.5 times or higher than the input voltage.

3. The drive circuit according to claim 1 or 2, wherein the high-side transistor and the low-side transistor are GaN-FETs (Field-Effect Transistors).

4. The drive circuit according to any one of claims 1 to 3, wherein a length of a wiring pattern from the input terminal to the switching node via the high-side transistor is longer than 100 μm.

5. The drive circuit according to any one of claims 1 to 3, wherein a length of a wiring pattern from the ground terminal to the switching node via the low-side transistor is longer than 100 μm.

6. The drive circuit according to any one of claims 1 to 5, further comprising a ferrite bead provided between an output node of a power supply circuit configured to generate the input voltage and the input terminal.

7. The drive circuit device according to any one of claims 1 to 6, further comprising a feedthrough capacitor connected to the input terminal.

8. The drive circuit according to any one of claims 1 to 7, wherein the control circuit is configured to turn off the high-side transistor and the low-side transistor during a third period which follows the second period.

9. An active sensor comprising:
a light-emitting device configured to irradiate a field of view with pulse illumination light; and
a light sensor configured to receive reflected light of the pulse illumination light from the field of view,
wherein the light-emitting device includes:
a semiconductor light-emitting element, and
the drive circuit according to any one of claims 1 to 8 configured to drive the semiconductor light-emitting element.

10. An object identification system comprising:
the active sensor according to claim 9; and
an arithmetic processing device configured to be capable of identifying a type of an object on the basis of an image obtained by the active sensor.
